(19) United States
(12) Patent Application Publication
(10) Pub. No.: US 2024/0096248 A1
(43) Pub. Date: Mar. 21, 2024

(54) FOLDABLE ADVERTISING BOARD

(71) Applicant: Baojian LI, Shenzhen (CN)

(72) Inventor: Baojian LI, Shenzhen (CN)

(21) Appl. No.: 17/948,342

(22) Filed: Sep. 20, 2022

(51) Int. Cl. G09F 13/04

(52) U.S. Cl. CPC G09F 13/0446

(57) ABSTRACT

A foldable advertising board is provided, including a first light board and a second light board. A right side of the first light board is formed with a protruding segment protruding outwardly, and front and rear edges of the protruding segment are respectively provided with first bushings that are arranged coaxially. A left side of the second light board is formed with a concave segment fitting with the protruding segment, and front and rear edges of the concave segment are respectively provided with second bushings that are rotatably fitted in the first bushings. A side edge of the second light board is provided with a wire hole, and a wire penetrates into the second light board through the wire hole and into the first light board through the first bushings and the second bushings.

### FIELD OF THE INVENTION

The utility model relates to the technical field of light-emitting advertisements, in particular, to a foldable advertising board.

### BACKGROUND OF THE INVENTION

Merchants will often arrange some light-emitting advertisements to provide simple information at the door or indoors of their business premises, so as to quickly convey information such as whether they are open or not and whether there are discounts to customers.

In the prior art, most of the above-mentioned light-emitting advertisements use an integrated integral board, which occupies a large space and cannot be changed, so it is inconvenient when the advertising board is stored and moved.

### BRIEF DESCRIPTION OF THE UTILITY MODEL

The utility model aims at providing a foldable advertising board, so as to overcome the above shortcomings in the prior art. Specifically, the technical solutions are as follows:

A foldable advertising board includes a first light board and a second light board that are hinged to each other at one side respectively, top surfaces of the first light board and the second light board being respectively embedded with a plurality of light beads;

a right side of the first light board is formed with a protruding segment protruding outwardly at a middle segment thereof, and front and rear edges of the protruding segment are respectively provided with first bushings that are fitted with each other coaxially;

a left side of the second light board is formed with a concave segment fitting with the protruding segment at a middle segment thereof, and front and rear edges of the concave segment are respectively provided with second bushings that are rotatably fitted in the first bushings;

a side edge of the second light board is provided with a wire hole, a wire and a switch, the wire penetrates into the second light board through the wire hole and into the first light board through the first bushings and the second bushings, the light bead is connected to an external power supply through the wire, and the switch is connected in series with the wire to form a power supply switch.

In the above technical solutions, the first light board and the second light board may be rotated relative to each other, so as to be used to realize a light-emitting advertising board after being flattened, or folded to reduce the volume for storage and carrying. The wire penetrates into the second light board through the wire hole and into the first light board through the first bushings and the second bushings, so that the wires are not repeatedly bent when the first light board and the second light board are rotated relative to each other.

Compared with the prior art, the utility model has the following beneficial effects: the foldable advertising is realized by the relative rotation and cooperation of the first light board and the second light board, which increases portability and practicability, and provides a protective structure against collapsing and folding for the wires to ensure the safety of electricity use.

The utility model is further described below with reference to the accompanying drawings and specific implementations of the specification.

### BRIEF DESCRIPTION OF THE DRAWINGS

FIG. 1 is a structure diagram of the utility model.

FIG. 2 is an exploded structure diagram of the utility model.

FIG. 3 is an assembly diagram of the utility model.

FIG. 4 is a reference diagram one of the use state of the utility model.

FIG. 5 is an exploded structure diagram of a first light board in the utility model.

FIG. 6 is an exploded structure diagram of a second light board in the utility model.

FIG. 7 is an assembly diagram of a first bushing and a second bushing in the utility model.

FIG. 8 is a structure diagram of a first block in the utility model.

FIG. 9 is a structure diagram of a second block in the utility model.

FIG. 10 is a reference diagram two of the use state of the utility model.

FIG. 11 is a partial enlarged diagram of A in FIG. 10.

FIG. 12 is a partial enlarged drawing of B in the FIG. 10.

### DETAILED DESCRIPTION OF THE INVENTION

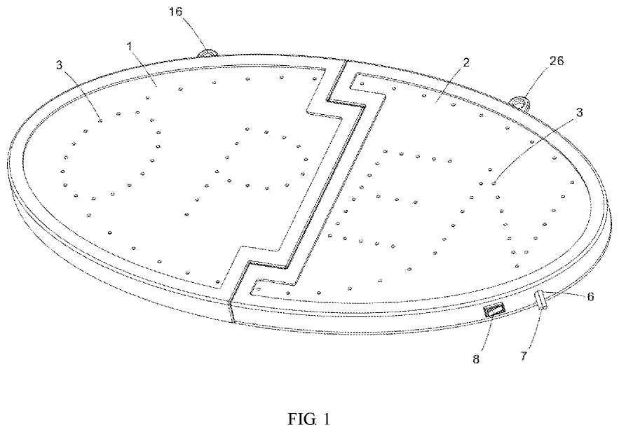

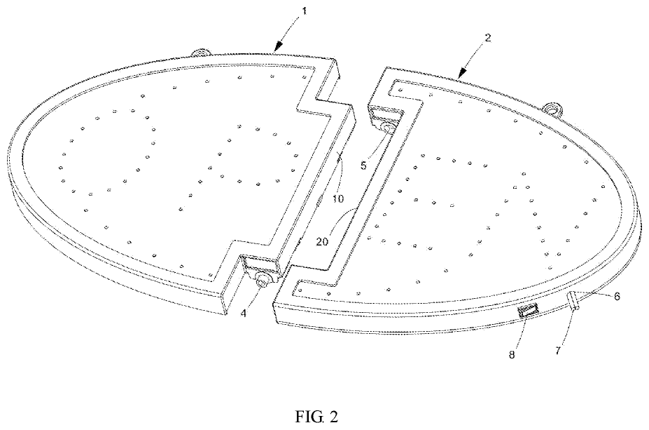

As shown in FIGS. 1 to 4, in an embodiment, the utility model adopts the following solutions.

A foldable advertising board includes a first light board 1 and a second light board 2 that are hinged to each other at one side respectively, top surfaces of the first light board 1 and the second light board 2 being respectively embedded with a plurality of light beads 3;

a right side of the first light board 1 is formed with a protruding segment 10 protruding outwardly at a middle segment thereof, and front and rear edges of the protruding segment 10 are respectively provided with first bushings 4 that are fitted with each other coaxially;

a left side of the second light board 2 is formed with a concave segment 20 fitting with the protruding segment 10 at a middle segment thereof, and front and rear edges of the concave segment 20 are respectively provided with second bushings 5 that are rotatably fitted in the first bushings 4;

a side edge of the second light board 2 is provided with a wire hole 6, a wire 7 and a switch 8, the wire 7 penetrates into the second light board 2 through the wire hole 6 and into the first light board 1 through the first bushings 4 and the second bushings 5, the light bead 3 is connected to an external power supply through the wire 7, and the switch 8 is connected in series with the wire 7 to form a power supply switch 8.

In the above embodiment, the first light board 1 and the second light board 2 may be rotated relative to each other, so as to be used to realize a light-emitting advertising board after being flattened, or folded to reduce the volume for storage and carrying, thereby increasing portability and practicality.

In addition, in the above embodiment, the wire 7 penetrates into the second light board 2 through the wire hole 6 and into the first light board 1 through the first bushings 4 and the second bushings 5, so that the wires 7 are not repeatedly bent when the first light board 1 and the second light board 2 are rotated relative to each other, thereby avoiding the wire 7 from bending and damage and ensuring the safety of electricity use.

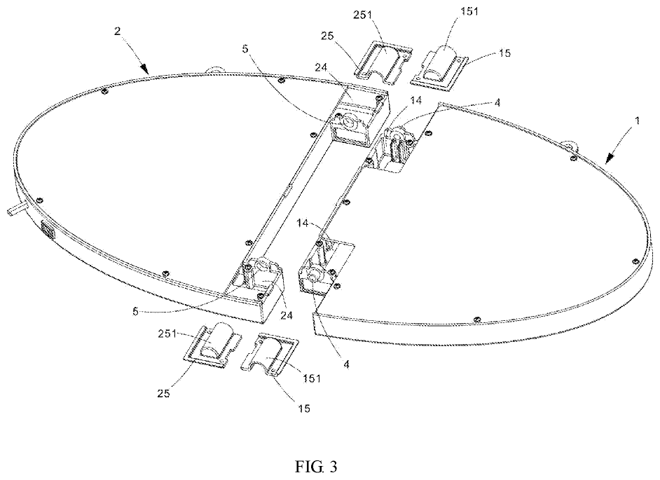

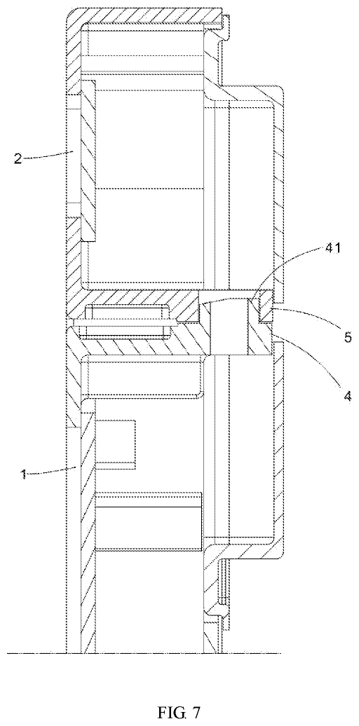

As shown in FIG. 3, in the above embodiment, the first light board 1 and the second light board 2 may also be detachably fitted with each other through the cooperation of the first bushings 4 and the second bushings 5. With reference to FIG. 7, specifically, the first bushing 4 is provided with a plug-in end 41 that may just be plugged into the second bushing 5, and the plug-in end 41 may enter or exit the second bushing 5 by elastic deformation under the action of radial external force. Therefore, for the first light board 1 and the second light board 2 in the split state, if the above two need to be assembled, first the second light board 2 is placed obliquely and the first bushing at the lower end of the protruding segment 10 is first inserted into the second bushing at the lower end of the concave segment 20 with the plug-in end, then the second light board 2 is erected step by step so that the first bushing at the upper end of the protruding segment 10 is radially close to the second bushing at the upper end of the concave segment 20 with the plug-in end, and finally a radial external force is applied to force the first bushing at the upper end of the protruding segment 10 to squeeze the plug end into the second bushing at the upper end of the concave segment 20 to complete insertion and fitting. Similarly, for the first light board 1 and the second light board 2 in an assembled state, if the above two need to be separated, a radial external force may be applied to force the first bushing at either end of the protruding segment 10 to disengage the plug-in end from the corresponding second bushing.

In order to achieve the detachable fit shown in FIG. 3, in a preferred embodiment, the first bushing 4 and/or the second bushing 5 may be made of a plastic material with an expected elastic performance.

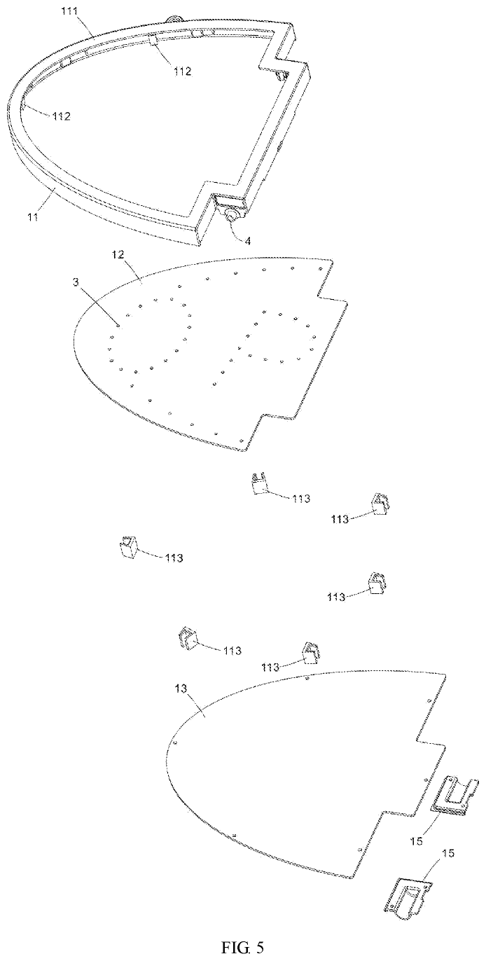

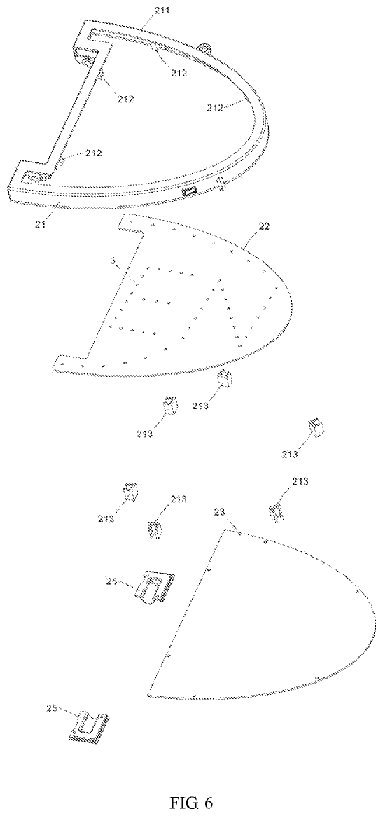

As shown in FIGS. 5 and 6, in another embodiment, the first light board 1 includes a first outer frame 11 for forming a peripheral outline, a first panel 12 connected to an opening at an upper end of the first outer frame 11, and a first backplane 13 connected to an opening at a lower end of the first outer frame 11; the second light board 2 includes a second outer frame 21 for forming a peripheral outline, a second panel 22 connected to an opening at an upper end of the second outer frame 21, and a second backplane 23 connected to an opening at a lower end of the second outer frame 21; the light beads 3 are arranged on the first panel 12 and the second panel 22.

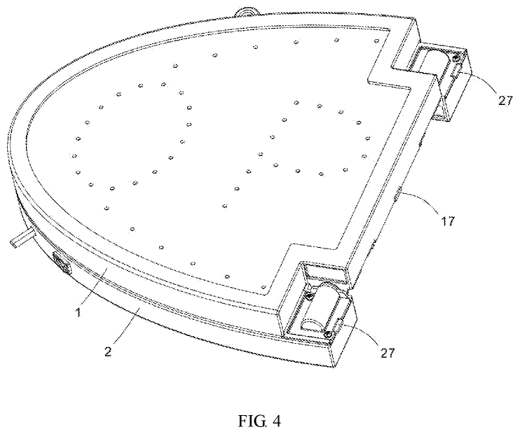

The first bushing 4 is arranged at an edge of the lower end of the first outer frame 11, and the second bushing 5 is arranged at an edge of the lower end of the second outer frame 21; when the first light board 1 and an second light board 2 are laid flat, the outer end surface of the protruding segment 10 abuts against an inner end surface of the concave segment 20, so that the first light board 1 and the second light board 2 may only rotate relative to each other and further may be folded into the state shown in FIG. 4.

Further, the first backplane 13 is left empty at the first bushing 4 to form a first escape opening 14, a bottom surface of the first light board 1 is provided with a first shaft cover 15 for covering the first escape opening 14, and the first shaft cover 15 is formed with a first raised portion 151 for accommodating the first bushing 4; the second backplane 23 is left empty at the second bushing 5 to form a second escape opening 24, a bottom surface of the second light board 2 is provided with a second shaft cover 25 for covering the second escape opening 24, and the second shaft cover 25 is formed with a second raised portion 251 for accommodating the second bushing 5. When the first light board 1 and the second light board 2 are in the assembled state, the first shaft cover 15 is used to protect the first bushing 4, and the second shaft cover 25 is used to protect the second bushing 5. When the first light board 1 and the second light board 2 need to be separated, the first shaft cover 15 and the second shaft cover 25 need to be removed first. Specifically, the first shaft cover 15 is locked to the first outer frame 11 using screws, and the second shaft cover 25 is locked to the second outer frame 21 using screws.

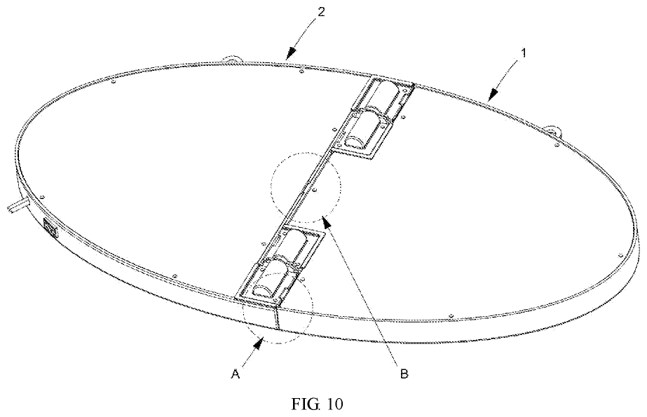

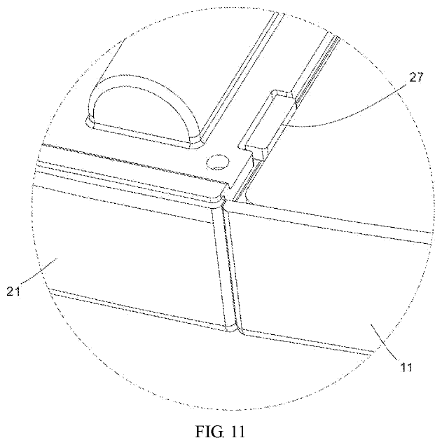

As shown in FIGS. 4, 10, 11 and 12, in another embodiment, an edge of the lower end of the first outer frame 11 that is fitted with the second outer frame 21 is provided with a first deadbolt 17 protruding outwardly, and the first deadbolt abuts against the edge of the lower end of the second outer frame 21 when the first light board 1 and the second light board 2 are laid flat. Further, an edge of the lower end of the second outer frame 21 that is fitted with the first outer frame 11 is provided with a second deadbolt 27 protruding outwardly, and the second deadbolt 27 abuts against the edge of the lower end of the first outer frame 11 when the first light board 1 and the second light board 2 are laid flat.

As shown in FIGS. 4, 10, 11 and 12, edges of the first outer frame 11 and the second outer frame 21 that are fitted with each other constitute an interference fit through the first deadbolt 17 and the second deadbolt 27 respectively. Specifically, when the first light board 1 and the second light board 2 are laid flat, since the first deadbolt 17 is pressed against the edge of the lower end of the second outer frame 21 and the second deadbolt 27 is pressed against the edge of the lower end of the first outer frame 11, the first light board 1 and the second light board 2 will remain in a flat state under the action of the first deadbolt 17 and the second deadbolt 27 when there is no external force. When the first light board 1 and the second light board 2 in the flat state start to rotate back and forth relative to each other under the action of external force, the first deadbolt 17 and the edge of the lower end of the second outer frame 21 interfere and squeeze each other, and the second deadbolt 27 and the edge of the lower end of the second outer frame 11 interfere and squeeze each other, and the first deadbolt 17 and the second deadbolt 27 will be elastically deformed due to extrusion during the above process, so that further the first deadbolt 17 is separated from the edge of the lower end of the second outer frame 21 and the second deadbolt 27 is separated from the edge of the lower end of the first outer frame 11, thereby finally forcing the first light board 1 and the second light board 2 to be relatively rotated back to the folded state shown in FIG. 4.

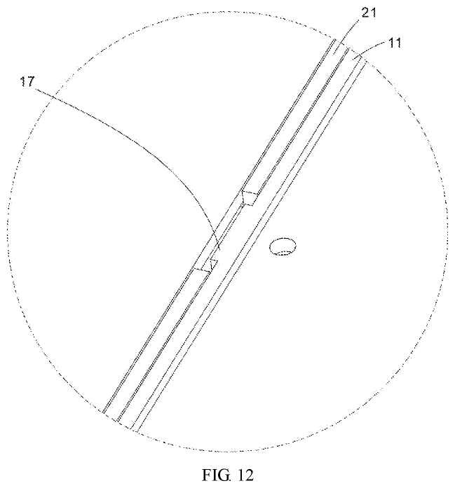

In order to facilitate the first outer frame 11 and the second outer frame 21 to realize the interference fit shown in FIGS. 11 and 12, in a preferred embodiment, the first outer frame 11 and the second outer frame 21 may be made of plastic materials with elastic performance that meet expectations, the first deadbolt 17 is integrally formed with the first outer frame 11, and the second deadbolt 27 is integrally formed with the second outer frame 21.

As shown in FIG. 1, in another embodiment, a rear edge of the first outer frame 11 is provided with a first hanging ring 16, and a rear edge of the second outer frame 21 is provided with a second hanging ring 26; through the first hanging ring 16 and the second hanging ring 26, the foldable advertising board of the utility model may be hung on a rope or a wall stud in a left-right balanced manner.

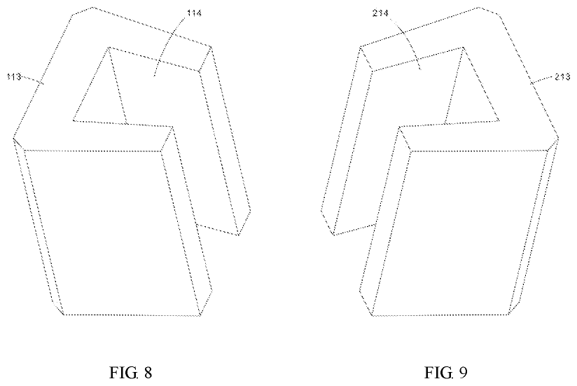

As shown in FIGS. 5, 6, 8 and 9, in another embodiment, the opening of the upper end of the first outer frame 11 is formed with a first baffle 111 around a first periphery of an inner edge, and a plurality of first connecting portions 112 are distributed around the first periphery of the inner edge of the first outer frame 11, a screw penetrating through the first backplane 13 from a bottom surface of the first backplane 13 to be screwed to the first connecting portion 112 for fastening the first backplane 13; a first side of the first connecting portion 112 opposite to an inner edge of the first outer frame 11 is provided with a pressing block 113, and the pressing block 113 is provided with a gap 114 for the first connecting portion 112 to be embedded to form a tight fit; the first backplane 13 abuts against the pressing block 113 upwardly, and the pressing block 113 abuts against the first panel 12 upwardly, so as to abut the first panel 12 against a bottom surface of the first baffle 111; the opening of the upper end of the second outer frame 21 is formed with a second baffle 211 around a second periphery of an inner edge, and a plurality of second connecting portions 212 are distributed around the second periphery of the inner edge of the second outer frame 21, a screw penetrating through the second backplane 23 from a bottom surface of the second backplane 23 to be screwed to the second connecting portion 212 for fastening the second backplane 23; a second side of the second connecting portion 212 opposite to the inner edge of the second outer frame 21 is provided with a second pressing block 213, and the second pressing block 213 is provided with a second gap 214 for the second connecting portion 212 to be embedded to form the tight fit; the second backplane 23 abuts against the second pressing block 213 upwardly, and the second pressing block 213 abuts against the second panel 22 upwardly, so as to abut the second panel 22 against the bottom surface of the second baffle 211.

For those skilled in the art, the protection scope of the utility model is not limited to the details of the above-mentioned exemplary embodiments. Without departing from the spirit or basic features of the utility model, those skilled in the art make equivalent meanings based on the requirements of the utility model and all modified embodiments within the protection scope shall be included in the utility model.

What is claimed is:

1. A foldable advertising board, comprising a first light board and a second light board that are hinged to each other at one side respectively, top surfaces of the first light board and the second light board being respectively embedded with a plurality of light beads;
wherein
a right side of the first light board is formed with a protruding segment protruding outwardly at a middle segment thereof, and front and rear edges of the protruding segment are respectively provided with first bushings that are fitted with each other coaxially;
a left side of the second light board is formed with a concave segment fitting with the protruding segment at a middle segment thereof, and front and rear edges of the concave segment are respectively provided with second bushings that are rotatably fitted in the first bushings;
a side edge of the second light board is provided with a wire hole, a wire and a switch, the wire penetrates into the second light board through the wire hole and into the first light board through the first bushings and the second bushings, the light bead is connected to an external power supply through the wire, and the switch is connected in series with the wire to form a power supply switch.

2. The foldable advertising board according to claim 1, wherein the first light board comprises a first outer frame for forming a peripheral outline, a first panel connected to an opening at an upper end of the first outer frame, and a first backplane connected to an opening at a lower end of the first outer frame; the second light board comprises a second outer frame for forming a peripheral outline, a second panel connected to an opening at an upper end of the second outer frame, and a second backplane connected to an opening at a lower end of the second outer frame; the light beads are arranged on the first panel and the second panel.

3. The foldable advertising board according to claim 2, wherein the first bushing is arranged at an edge of the lower end of the first outer frame, and the second bushing is arranged at an edge of the lower end of the second outer frame; when the first light board and an second light board are laid flat, the outer end surface of the protruding segment abuts against an inner end surface of the concave segment, so that the first light board and the second light board may only rotate relative to each other.

4. The foldable advertising board according to claim 3, wherein the first backplane is left empty at the first bushing to form a first escape opening, a bottom surface of the first light board is provided with a first shaft cover for covering the first escape opening, and the first shaft cover is formed with a first raised portion for accommodating the first bushing; the second backplane is left empty at the second bushing to form a second escape opening, a bottom surface of the second light board is provided with a second shaft cover for covering the second escape opening, and the second shaft cover is formed with a second raised portion for accommodating the second bushing.

5. The foldable advertising board according to claim 3, wherein an edge of the lower end of the first outer frame that is fitted with the second outer frame is provided with a first deadbolt protruding outwardly, and the first deadbolt abuts against the edge of the lower end of the second outer frame when the first light board and the second light board are laid flat.

6. The foldable advertising board according to claim 3, wherein an edge of the lower end of the second outer frame that is fitted with the first outer frame is provided with a second deadbolt protruding outwardly, and the second deadbolt abuts against the edge of the lower end of the first outer frame when the first light board and the second light board are laid flat.

7. The foldable advertising board according to claim 2, wherein a rear edge of the first outer frame is provided with a first hanging ring, and a rear edge of the second outer frame is provided with a second hanging ring.

8. The foldable advertising board according to claim 2, wherein the opening of the upper end of the first outer frame is formed with a first baffle around a first periphery of an inner edge, and a plurality of first connecting portions are distributed around the first periphery of the inner edge of the first outer frame, a screw penetrating through the first backplane from a bottom surface of the first backplane to be screwed to the first connecting portion for fastening the first backplane; a first side of the first connecting portion opposite to an inner edge of the first outer frame is provided with a pressing block, and the pressing block is provided with a gap for the first connecting portion to be embedded to form a tight fit; the second backplane abuts against the pressing block upwardly, and the pressing block abuts against the second panel upwardly, so as to abut the second panel against a bottom surface of the second baffle; the opening of the upper end of the second outer frame is formed with a second baffle around a second periphery of an inner edge, and a plurality of second connecting portions are distributed around the second periphery of the inner edge of the second outer frame, a screw penetrating through the second backplane from a bottom surface of the second backplane to be screwed to the second connecting portion for fastening the second backplane; a second side of the second connecting portion opposite to the inner edge of the second outer frame is provided with the pressing block, and the pressing block is provided with a gap for the second connecting portion to be embedded to form the tight fit; the second backplane abuts against the pressing block upwardly, and the pressing block abuts against the second panel upwardly, so as to abut the second panel against the bottom surface of the second baffle.
